(19) United States
(12) Patent Application Publication
(10) Pub. No.: US 2008/0091604 A1
(43) Pub. Date: Apr. 17, 2008

(54) Method for the Compartmented Provisioning of an Electronic Service

(75) Inventor: Jean-Phillipe Wary, Bourg La Reine (FR)

Correspondence Address: PERMAN & GREEN, 425 POST ROAD, FAIRFIELD, CT, 06824, US

(73) Assignee: SOCIETE FRANCAISE DU RADIOTELEPHONE, Paris (FR)

(21) Appl. No.: 11/867,058

(22) Filed: Oct. 4, 2007

(30) Foreign Application Priority Data
Oct. 5, 2006 (FR) 06 54118

(51) Int. Cl. H04L 9/32; G06Q 10/00

(52) U.S. Cl. 705/50

(57) ABSTRACT

To enable services to be proposed in an optimal way on mobile terminals, the method provides for the compartmented provisioning of an electronic service on a user's electronic terminal to at least one provider subscribing to the service, the provider proposing this service to a plurality of consumers through the setting up, in a preliminary step, of a security domain guaranteeing the compartmentation of the service and of a data zone which the service can access, either directly or through a processing of the electronic service, the data zone of the security domain being accessible only through a data access key. In disclosed embodiments, the terminal indexes, in the security domain, the data zone which the service can access in the electronic terminal in sub-zones to guarantee that a request by one consumer among the plurality of consumers can read/write/modify only one predetermined sub-zone associated with the customer who is the sender of the request, either directly or through the electronic service.

### BACKGROUND OF DISCLOSED EMBODIMENTS

1. Field

The disclosed embodiments are directed to the compartmented provisioning of an electronic service.

The field of disclosed embodiments is that of mobile terminals and more particularly that of the services provided through these mobile terminals. The term “mobile terminal” is understood to mean a second-generation or higher than second-generation mobile telephone. By extension, a mobile terminal is any device that can communicate through a network and be transported by a human without assistance. This category therefore includes at least mobile telephones, personal digital assistants and laptops.

The aim of disclosed embodiments is service provisioning (i.e. making services available) on a mobile telephone in saving the resources of this terminal.

Another aim of disclosed embodiments, in a given terminal is to provision this service or make it available to a plurality of consumers in saving the resources of said terminal.

Another aim of disclosed embodiments is to secure the provisioning of the service.

2. Description of the Prior Art

In the prior art, there are known mobile telephony software platforms that enable services other than those of mobile telephony to be proposed on mobile telephones.

One of these solutions lies in wiring the service into a chip which is embedded in the telephone. In this case, the service is dedicated to a provider and to a consumer of the service. If the services have to be increased, then the chips in the telephone, i.e. the connectors as well, need to be increased and this soon becomes very costly. However, this approach ensures efficient compartmenting between the services which in fact all correspond to a different chip and therefore to a different physical memory. However, the cost of implementing more than one service is dissuasive.

Another of these approaches is a purely software architecture applying the concept of a security domain. A security domain is defined at the level of the operating system of the mobile telephone, or at an over-layer of the operating system. Such an over-layer is, for example, a Java type virtual machine. The security domain has at least one memory zone divided into a program zone and a data zone. The mechanisms of the operating system or of the over-layer ensure that the instruction codes of the program zone of the security domain can access only data from the data zone of said security domain. This access to the security domain is furthermore protected by a set of keys or “keyset”. Thus, there are several keys associated with a security domain. Thus, the technical domain introduces the notion of the keyset which plays a role in the protection of the security domain. Each of these keys is dedicated to one very precise role or one very precise security function depending on the needs of securing the security domain. The following list of security keys or functions is not exhaustive but, for the securing of a domain, several keys can be applied depending on the security needs proper to the domain considered. Thus, there may be one key to instantiate services in the security domain, one key to activate these services, one key to authenticate access to these services, one key to encipher communications with these services and one key to modify the parameters of the security domain, i.e. to modify the content of the data zone of said domain. Only knowledge of the right key, or of a means of access to the right key, would make it possible to undertake the desired action.

These mechanisms are used to ensure efficient compartmenting of data between the different security domains should the underlying operating system implement the appropriate compartmenting (this is the Java firewalling or sandbox concept). However, this approach has at least one major drawback. Indeed, a service is rendered to a customer who places importance on the confidentiality of his data. It is therefore necessary, for each consumer to install a distinct security zone in the mobile telephone of each of the users of the service. Hence, if an operator managing the mobile telephone wishes to propose the same secured service to two different consumers, he is obliged to install the security domain twice on the user's terminal and provide for two sets of keys, one for each of the consumers. These installations are multiplied with the number of services and the number of consumers for each of the services or for all of these services. This results in increasing the resources that must be available to a mobile telephone, and hence in increasing its cost and/or reducing its performance for a given service.

In the context of the world of the JavaCard™ and of the “Global Platform”, (http://www.globalplatform.org/), the notion of security domain is proposed but comes up against the same limitation, namely the obligation to multiply the security domains in order to instantiate a same “applet” (application in metalangage on the customer side) several times for different data and for which the confidentiality and compartmentation has to be guaranteed for both service providers and consumers of the service. In the prior art, as regards the Java smartcard, we have gone from a model-application card to multi-application card with a Global Platform type model but disclosed embodiments proposes to resolve the problems identified here above in passing from the notion of the Java multi-application smartcard to the Java multi-data multi-application smartcard in enabling the propagation of the native Java compartmentation system up to data managed by a same application.

It would be advantageous to resolve these problems by proposing a method for the compartmented provisioning of an electronic service on an electronic terminal to at least one provider who is a subscriber to the service, said provider proposing this service to a plurality of consumers through the setting up, in a preliminary step, of a security domain ensuring the compartmenting of the service and a data zone to which said service can obtain access, either directly through the processing of the electronic service, the data zone of the security domain being acceptable only through an access key to the data. In disclosed embodiments, in the security domain, the data zone to which the service can obtain access on the electronic terminal is, in a noteworthy way, indexed into sub-zones to ensure that a request from a consumer out of the plurality of consumers can read/write/modify only one predetermined sub-zone associated with the request-sending consumer, either directly or through the processing of the electronic service.

Thus, only the resources of a security domain are used to propose a service to at least one service provider itself providing this service to a plurality of consumers.

### SUMMARY

Aspects of disclosed embodiments are directed to a method for the compartmented provisioning of an electronic service on an electronic terminal to at least one provider subscribing to the service and proposing the service to a plurality of consumers through a security domain guaranteeing the compartmentation of the service and of a data zone which said service can access, the data zone of the security domain being accessible only through a data access key, wherein:
in the security domain, the data zone which the service can access in the electronic terminal is indexed in a sub-zone to guarantee that a request by one consumer among the plurality of consumers can read/write/modify only one predetermined sub-zone associated with the customer who is the sender of the request.

According to one variant of the method of disclosed embodiments, the indexing is done locally on the terminal and by the service through the presentation by the consumer to the service of at least one identifier enabling the unlocking of access to the data sub-zone associated with the consumer identified by the identifier.

In another variant of the method of disclosed embodiments, the identification is followed by an authentication based on an enciphering key which the service is capable of producing from at least the identifier of the consumer.

In another variant of the method of disclosed embodiments, the indexing is done by a third-party device wherein the third-party device, upon reception of a request from a consumer, implements the following steps:
identification of the requested service,
identification of the terminal on which the service is requested,
identification of the consumer,
and, in the event of positive identification, sending of an update request to the identified terminal to take account of the request from the consumer.

In one variant, the method of disclosed embodiments is also characterized in that the identification of the provider is followed by an authentication.

In one variant, the method of disclosed embodiments is also characterized in that the updating request is enciphered with the data access key.

In one variant, the method of disclosed embodiments is also characterized in that the provider, through specific requests to the service or operating system of the security domain or the operating system of the terminal, can directly perform all the operations of management of the indexed data zone such as creation, initialization, locking, destruction, synchronization of the data between different consumers and/or users (the list is not exhaustive). These management operations can be protected by different keys or keysets known to the provider.

In one variant of the method of disclosed embodiments, the indexing of the data zone is done on the basis of information identifying the user of the zone on the terminal. It is thus possible to manage several users on a same terminal for one or more consumers with one or more service providers. This variant, inter alia, enables the synchronization of information between a plurality of users for one or more consumers of a same service.

### BRIEF DESCRIPTION OF THE DRAWINGS

The aspects of the disclosed embodiments will be understood more clearly from the following description and the accompanying figures. These figures are given by way of an indication and in no way restrict the scope of disclosed embodiments. Of these figures:

FIG. 1 illustrates devices whose memories are structured according to steps of the method of disclosed embodiments in a local or remote implementation,

FIG. 2 illustrates the steps of the method of disclosed embodiments in a local implementation,

FIG. 3 also illustrate steps of the method of disclosed embodiments in a remote implementation,

FIG. 4 illustrates an indexing table.

### MORE DETAILED DESCRIPTION

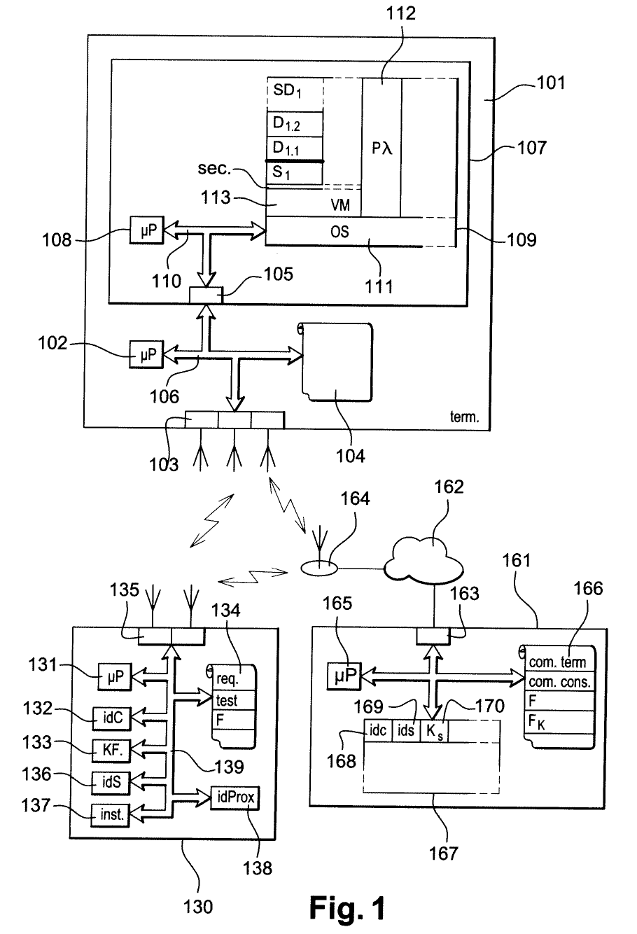

FIG. 1 shows a mobile terminal 101 implementing the method of disclosed embodiments. In the present example, the terminal 101 is a mobile telephone. In practice, the figure may pertain to all the devices already cited in the introduction. FIG. 1 shows that the telephone 101 has at least one microprocessor 102, communications interface circuits 103, a program memory 104 and a microcircuit card reader 105. The elements 102 to 105 are interconnected by a bus 106.

In this document, when an action is attributed to a device, this action is actually performed by a microprocessor of said device controlled by instruction codes of a program memory of said device. When an action is attributed to a program, this action corresponds to the execution of all or part of the instruction codes of a zone of a program memory, said zone corresponding then to the program, by a microprocessor of the device to which the program memory in which the program is recorded belongs.

In this document, the term “service” is used to designate a program corresponding to an offer of a service vended by an operator to a provider.

Thus, for example, a mobile telephony operator sells an accounting service for customer loyalty points to a service provider. This provider in turn has customers who are service consumers, for example a baker, a vendor of disks or any unspecified goods. These customers are consumers of the accounting service for customer loyalty points. This service consumer may, in turn, propose an electronic loyalty card to his final customers, i.e. the man in the street. In one terminal, the same service/program can therefore be used for several consumers, in this case for several shops.

Examples of services, in addition to the one just described, are end-to-end enciphering services, mutual authentication services, electronic rights management services, payment services, electronic signature services etc: the list is not exhaustive.

In one variant of disclosed embodiments, the provider is the same as the telephony operator himself.

The circuits 103 enable the telephone 101 to communicate according to various standards, among them mobile telephony standards, and do so in all voice/data modes as well as local communications standards such as BlueTooth®, Wifi, as well as standards known as contactless standards such as RFID/NFC standards.

The circuits 105 enable the telephone 101 to interface with a 107 SIM/USIM (Subscriber Identification Module /UMTS) card 107. The card 107 has at least one microprocessor 108 and a program memory 109. The elements 105, 108 and 109 are interconnected via a bus 110.

The memory 109 classically has a zone 111 with instruction codes corresponding to an operating system. The operating system enables programs installed in the card 107 to access resources (communications, file systems etc) of the card 107. All the programs installed in the card 107 therefore use functions of the operating system 111.

FIG. 1 shows a zone 112 of the memory 109 corresponding to any typical program and therefore comprising instruction codes directly connected to the operating system 111.

Disclosed embodiments uses the known mechanism of the security domain. This mechanism implies the implementation of additional functions in the operating system. These mechanisms are obtained in practice by a virtual machine, for example a Java virtual machine. FIG. 1 shows a virtual machine 113 of this kind. In principle, this virtual machine is an intermediary between calls made by a program written for the virtual machine and the operating system in which the virtual machine is installed.

In practice, virtual machines are able to create security domains, i.e. the security domains may be created when the card is put into production or they may be created dynamically after the phase in which the card is put into production. FIG. 1 shows a security domain SD1. The domain SD1 is a zone of the memory 109. The domain SD1 has a zone SI corresponding to instruction codes that can be interpreted by the machine 113 and corresponding to the performance of a service such as those mentioned here above.

The domain SD1 also has a data zone. In disclosed embodiments, this data zone is subdivided into sub-zones D1.1, D1.2 to D1.n. The mechanism of the security domain ensures that only the instruction codes of the zone S1 can access data of the data zone of SD1. Disclosed embodiments enables each sub-zone D1.x to be associated with a given consumer. Depending on the consumer who will invoke the service S1, only one sub-zone will be available. Each service, and therefore each security domain, is identified by a service identifier Sx. Each consumer is identified by a consumer identifier idC.

To this end, the machine 113 and/or the zone S1 comprise instruction codes recorded in a zone SEC and dedicated to the verification of the validity of a request addressed to the service S1, or generally to the service Sx. Each security domain has its own zone. The codes recorded in the zone therefore guarantee the indexing of the data zone.

When it is said that the service S1 communicates with the exterior, it does so through the SIM card 107 and the telephone 101.

FIG. 1 shows a consumer device 130 used by a consumer wishing to send requests to the service S1. The device 103 comprises a microprocessor 131, an identifier memory 132, a memory 133 of enciphering and authentication keys, a program memory 134 and communications interface circuits 135. The device 130 also has a memory 136 for identifying a service, and an instructions memory 137 and, in one variant, a memory 138 for the identification of a proxy server.

The elements 131 to 138 are interconnected via a bus 139. The circuits 135 are of a same nature as the circus 103 and are compatible with at least one of the standards among those implemented by the circuits 103.

The memory 134 comprises at least instruction codes for sending a request to the service S1. In one variant of disclosed embodiments, the memory 134 also has instruction codes to enable the reading of an authentication challenge submitted by the service S1. In one variant, the memory 134 has instruction codes for the implementation of a symmetrical or asymmetrical enciphering function F.

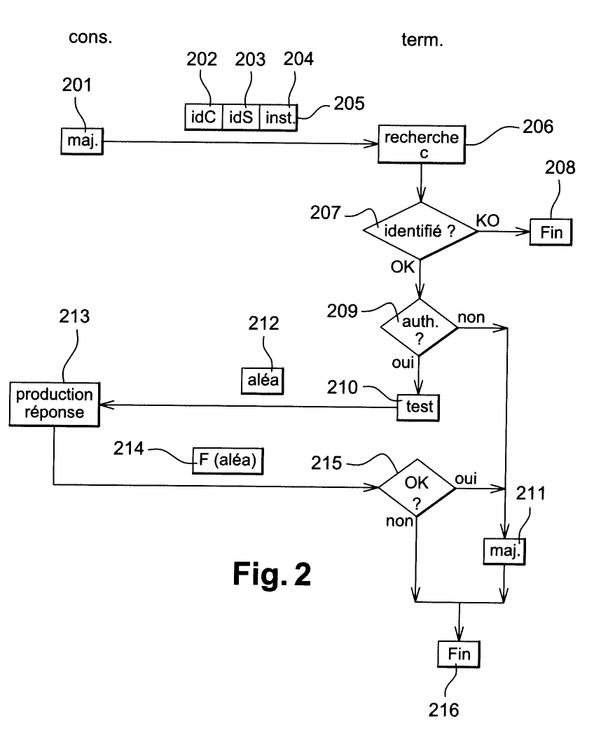

FIG. 2 illustrates the steps of the method according to disclosed embodiments when the indexing of the data zone of the security domain SD1 is managed locally by the SIM card 107.

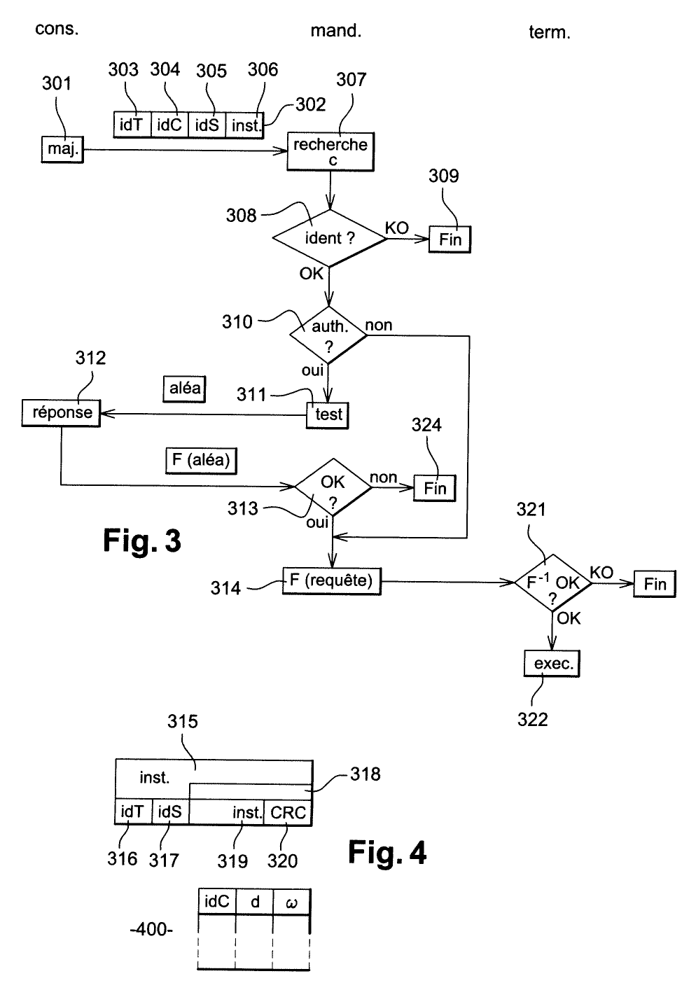

Prior to the performance of the steps which are be described for FIGS. 2 and 3, an operator will have implemented a step for the installation of the services in the card 107. In this step, the operator structures the memory 109 as described for FIG. 1. That is, the operator installs at least one security domain such as the domain SD1, in the memory 109.

FIG. 2 shows a step 21 in which the consumer activates the device 130 to make it interact with the telephone 101. This activation is done, for example, through a mechanical control interface while a bearer of the telephone 101 brings the telephone closer to the device 130. In this case, communication between the device 130 and the telephone 101 is done non-restrictively through RFID/NFC type mechanisms, or infrared or Bluetooth® type mechanisms or any other means of proximity communications or through data communications transported on a mobile or fixed network infrastructure.

The device 130 produces a request 205 comprising at least one identifier 202 of the consumer, one identifier 203 of the service and one instruction code 204. In the present example, these pieces of information are sent through only one request. In practice, they could be sent through an exchange of requests between the device 130 and the telephone 101. The pieces of information needed to produce the request 205 are read in the memories 132, 136 and 137. These memories are updated by the operator/provider when he supplies the device 130 to the consumer. The content of the field 204 can vary according to the consumer's wishes and through a parametrizing of the device 130. On the contrary, the fields 202 and 203 are under the provider's control, as is the memory 133.

Once produced, the request 205 is sent to the telephone 101.

In a step 206, the telephone 101 receives the request 205 and transmits it to the card 107 which processes it. This processing consists at least in reading the field 203 to identify a service and therefore a security domain. If the service designated by the field 203 exists, then the request 205 is processed by this service. Let us consider here that it is, for example, the service Si. The service Si then processes the request 205. If the service designated by the request 205 is not found, then this request is quite simply ignored. The processing of the request 205 by the service SI consists at least initially in reading the field 202 and in making a search to see whether a zone D1.x corresponds to the consumer thus designated. This research actually corresponds to an identification made during a step 207. If the service does not manage to identify a consumer then the operation passes to an end step 208 which amounts to ignoring the request 205. Else, the operation passes to a step 209 for testing an authentication.

The step 209 is a variant of disclosed embodiments. In the step 209 the service performs a test to find out whether, by configuration, the application of the service requires authentication after identification. If this is the case, the service Si passes to a step 210 of authentication of the consumer. If not, it passes to a step 211 of execution of the instruction code described in the field 204.

In the step 210, the service carries out an implicit or explicit one-way authentication or mutual authentication of the consumer through one or more exchanges. An implicit authentication is an authentication based on the reception/transmission of a value which is the result of a cryptographic operation establishing the possession of said authentication secret by the entity that has to be authenticated.

In a preferred variant of the step 210, the card 109 produces a challenge message 212 comprising a random variable. This message 212 is received in a step 213 by the device 130. In the step 213, the device 130 enciphers the random variable with the function F known to the device 130 and with the key of the memory 133. In one variant of the step 213, the device 130 computes a diversification of the key of the memory 133 from the value of the random variable and from a diversification or hashing function or a one-way function F known to the device 130. The key of the memory 133 is actually a key Kf that is an offspring of the key Ks of the keyset associated with the security domain SD1. We therefore have:
Kf=Fk (idC, Ks)
where idC is the content of the memory 132.

At the installation of the security domain, the card 109 knows Ks. According to this variant of disclosed embodiments, the service S1 knows Fk and F. These functions Fk are installed at the same time as the security domains of the memory 109. Finally, through the request 205, the service S1 knows idC.

At the end of the step 213, the device 130 sends out a response message 214 comprising F (random variable, Kf).

In a step 215, the service S1 receives the message 214 through the card 107 and the telephone 101. The service S1 then compares the content of the message 214 with its own computation F(random variable, Fk(idC, Ks)). If these computations are equal, then the service S1 passes to the step 221. If not it passes to an end step 216 and the request 205 is ignored.

In the step 211, the service S1 executes the instruction or instructions described in the field 204. This execution implies read and/or write operations in the data zone of the safety domain. In disclosed embodiments, the service S1 associates a sub-zone of the data zone with each consumer identifier. This association is made, for example, via the zone SEC corresponding to the security domain, or directly by the service S1. This zone then describes, for each consumer identifier, the sub-zone in which it is necessary to read/write/modify. Any attempt to read or write outside this sub-zone would lead to a rejection of execution on the part of the virtual machine.

In one variant of disclosed embodiments, the instruction received via the field 204 is enciphered with the key Kf of the memory 133 and the function F. This instruction can therefore be properly executed only if the consumer has correctly identified himself and if he had given the right details to the service S1 to decode the instruction. An enciphering mechanism of this kind shall be described in the variant illustrated in FIG. 3.

FIG. 3 illustrates a variant of disclosed embodiments in which the updating/reading of a sub-zone of a security domain is done through a proxy server of a provider having proposed a service to service consumers.

FIG. 1 illustrates a proxy server 161 of this kind. The server 161 is connected to a network 162 via interface circuits 163. The device 130 is capable of getting connected to the network 162 for example through a base station 164 of a mobile telephony network. The network may also be a fixed network or directly the Internet. The device 130 and the server 161 can therefore communicate.

The server 161 comprises a microprocessor 165, a program memory 166 and a configuration memory 167.

The memory 166 has instruction codes for the application of a communication with the device 130, instruction codes for the implementation of a communication with the services installed in the SIM card 107 of the telephone 101, instruction codes for the application of a symmetrical enciphering function F and instruction codes for the implementation of a function Fk for the production of an enciphering key Kf.

In this variant of disclosed embodiments, the security zone SEC of the security domains installed in the card 109 knows and is capable of implementing the function F. The memory 133 comprises the value:
Kf=Fk (idC, Ks)
each of these symbols having been described previously.

The memory 167 actually corresponds to a table, each row of the table corresponding to one consumer. Each row therefore has at least one consumer identifier field 168, one service identifier field 169 and one enciphering key field 170. The content of the field 170 is actually one of the keys of the keyset associated with the security domain in which the service identified by the field 169 is implemented.

FIG. 3 shows a step 201 in which a user of the device 120 produces and sends a request 302 to access a service installed in the telephone 101. This request comprises several fields, among them at least one field 303 identifying the terminal 101, one field 304 identifying the consumer, one field 305 identifying a service and one field 306 describing an instruction code that the service identified by the content of the field 305 must be made to execute. This request 302, once produced, is sent to the server 161 whose device 130 knows the address through the content of the field 138. This emission is done in data mode (TCP/IP type protocol) or through a short message (SMS/MMS type protocol).

As in the case of the step 201, the information described for the frame 302 will be sent by the device 130. However, this information can be sent in a single frame as described or in several frames during a dialog between the device 130 and the server 161.

In a preferred example, the content of the field 303 is a telephone number (MSISDN) by which the telephone 101 can be called. This telephone number is obtained by the device 130, either during a keying-in operation or in the course of a dialog between the telephone 101 and a device 130. Non-exhaustively, the content of the field 303 could be any network identifier of the subscriber, an IMSI or IMEI message in the context of a mobile network, but also an ICCID type identifier of the subscriber's smartcard or the TAR frame obtained by the telephone when the smartcard is booted. This identifier can also be based on any means of identification of the user with the connection operator: an IPv6address, and Ethernet address, even a mail address, an SIP or VOIP type identifier, an ENUM type identifier or any other electronic identity which can also be envisaged.

In a step 307, the server 161 undertakes a search in the table 167. The search is an identification 308 of the consumer who has sent out the request 302. This search consists of a search for a row of the table 167 whose fields 168 and 169 are equal to the fields 304 and 305. If a row L of this kind is found, then the identification is positive. If not, the identification is negative and the server 161 passes to a step 309 in which it ignores the request 302.

In the event of a positive authentication, the server 161 passes to an authentication test step 310. The step consists in determining whether an authentication is required in addition to the identification. This step is optional and can be done through a field of configuration of the row L. If this field is equal to 1, for example, then the authentication is required. If not, authentication is not required.

If the authentication is required, the server passes to a step 311 of submitting a challenge to the device 130. The step 311 is identical to the step 210 already described and is followed by the steps 312, 313 and 324 which are identical to the steps 213, 215 and 216. In this case, however, the steps 312, 313 and 324 are implemented by the server 161 and not by the card 107.

In the event of success of the authentication demand submitted by the server 161, the server passes to a step 314 of production of an instruction request 315.

In a preferred example, the instruction request 315 comprises at least, in a header, a field 316 identifying the destination telephone of the instruction request. The request is sent, for example, through a short message or any other communications means depending on the type of network identifier used. The field 316 comprises the value received by the server 161 through the field 303.

The request 315 also has a service identifier 317 whose content corresponds to the content of the field 169 of the row L found at the step 308.

The request 315 also has a field 318 enciphered by the function F through the use of the key Ks of the field 170 of the row L. Clearly, the field 318 comprises at least one field 319 describing the instruction to be executed and, optionally, a checksum (CRC) type field 320. The field 320 has a checksum of the field 319.

The key Ks is actually the access key to the data of the keyset of the security domain in which the service identified by the field 169 is executed.

The field 319 can be more complex, comprising a series of instructions and/or parameters for instruction. The 50 19 implicitly or explicitly comprises an identification of the consumer who has sent the request leading to the production of the instruction 315. This identification is, for example, an identifier enabling the service identified by the field 317 to determine a sub-zone of the data zone of the security domain in which the service is performed. This identification is, for example, implicitly contained in the parameters of the instruction or instructions to be executed. These parameters designate data to be updated or to be read. The server 161 uses its knowledge of the consumer's identity to produce instructions, for the field 319, which read and write only in a sub-zone attributed to the consumer identified in the row L. Knowledge of this sub-zone is then stored in the row L. In one variant, the knowledge of this sub-zone is stored in the zone SEC of the security domain.

Once the instruction request 315 has been produced, it is sent to the telephone 101 which receives it in a step 321 and transmits it to the card 107. The card 107 then uses the content of the field 317 to transmit the request 315 to the service identified by the field 317 if it exists. If not, the request 315 is ignored. In the present example, the service is deemed to be the service S1.

In the step 321, the service S1 uses the key Ks to decipher the field 318. Then, the service S1 computes a checksum of the content of the deciphered field 319 and compares the result of this sum with the content of the deciphered field 320, if the checksum option (CRC) is implemented. If this comparison is an equality, then the service S1 passes to a step 322 of execution of the instructions described by the content of the deciphered field 319. If not, the request 315 is ignored by the service.

In this variant, the indexing of the data is therefore ensured by a third-party server which, by the instructions that it sends to a given server, after having identified and/or authenticated a consumer, guarantees that this consumer will have access only to the data that concern him.

In one variant, the consumer device is actually an application installed in the program memory 104 of the terminal 101 (for example a messaging application or a <<multimedia player>> type application which has to manage data pertaining to the DRM and enciphered streaming streams or a multimedia data exchange/sharing application, or again a telephony or visiophony on IP type application). This program may then need enciphering services or a rights management service to enable the user of the telephone 101 to communicate with one or more content servers. In this case, the application is identified as a consumer and has access only to a sub-zone of the data zone of the security domain in which the enciphering service or rights management service is executed. In this case of a generic application, it is the content server that provides a generic application the information enabling it to identify itself as a service.

In disclosed embodiments, several security domains, hence several services, can coexist in the same SIM card. It is therefore possible to propose the same service to several consumers through a single security domain. It is also possible to render several services to several consumers through several security domains.

In one variant of the device, the method of disclosed embodiments is remarkable in that the indexing of the data zone is done from information identifying the user of the zone on the terminal. It is thus possible to manage several users on a same terminal 41 for one or more consumers with one or more providers or services. This variant makes it possible, inter alia, to synchronize information between a plurality of users for one or more consumers of a same service.

In practice, the security domains are implemented through a Java platform. The Java virtual machine is then used. The programs corresponding to the services are then called “applets” or Java applications executed in a customer device.

As already described, the indexing of a data zone of a security domain is done either locally by the service or remotely by a proxy server. In the examples described, this indexing is done through an “allocation table” 400 associating a consumer identifier with a description of a memory zone. Such a description corresponds, for example, to starting and ending addresses of the memory zone. In one variant of disclosed embodiments, each sub-zone is considered to have the same size. A data zone is then seen as a table, each box of the table then corresponding to a sub-zone. In this case, a simple index enables direct access to the right sub-zone. Yet another variant uses a sequential indexing where each sub-zone stores a consumer identifier, the election of the right sub-zone being then done by a sequential scan of the sub-zones until the right identifier is found. The instruction codes produced take account of the indexing mode.

In disclosed embodiments, the applets and the security domains are installed by the operator who has provided the SIM card. This enables the operator to ensure the quality and innocuous nature of the codes through different methods of formal analysis. This also enables the operator to pre-format the data zones of the security zones.

For the maintenance of these applications, the method of disclosed embodiments enables the operator/provider, through specific requests to the service or operating system of the security domain, or the operating system of the terminal, to directly perform all the operations for managing the indexed data zone, for example creation, initialization, locking, destruction, synchronization of data between different consumers and/or users etc. These management operations can be protected by different keys known to the provider.

Inasmuch as the operator/provider knows all or part of the keyset associated with a security domain, he can, as in the case described for remote indexing, produce an instruction which will be recognized and executed by the service which has to be maintained. In one variant, for the maintenance, the operator/provider identifies/authenticates itself as a super consumer to which the security domain grants all rights over its entire data zone.

1. A method for the compartmented provisioning of an electronic service on a user's electronic terminal to at least one provider subscribing to the service, said provider proposing this service to a plurality of consumers through the setting up, in a preliminary step, of a security domain guaranteeing the compartmentation of the service and of a data zone which said service can access, either directly or through a processing of the electronic service, the data zone of the security domain being accessible only through a data access key, wherein it comprises:
the terminal indexes, in the security domain, the data zone which the service can access in the electronic terminal in sub-zones to guarantee that a request by one consumer among the plurality of consumers can read/write/modify only one predetermined sub-zone associated with the customer who is the sender of the request, either directly or through the electronic service.

2. A method according to claim 1, wherein the indexing is done locally on the terminal and by the service through the presentation by the consumer to the service of at least one identifier enabling the unlocking of access to the data sub-zone associated with the consumer identified by the identifier.

3. A method according to claim 2, wherein the identification is followed by an authentication based on an enciphering key which the service is capable of producing from at least the identifier of the consumer.

4. A method according to claim 1 wherein the indexing is done by a third-party device wherein the third-party device, upon reception of a request from a consumer, implements the following:
identification of the requested service,
identification of the terminal on which the service is requested,
identification of the consumer,
and, in the event of positive identification, sending of an update request to the identified terminal to take account of the request from the consumer.

5. A method according to claim 4, wherein the identification of the provider is followed by an authentication.

6. A method according to claim 4, wherein the updating request is enciphered with the data access key.

7. A method according to claim 1, wherein the provider can, through specific requests to the service or operating system of the security domain or the operating system of the terminal, directly perform all the operations of management of the indexed data zone such as creation, initialization, locking, destruction, synchronization of the data between different consumers and/or users etc., where these management operations can be protected by different keys known to the provider.

8. A method according to claim 1, wherein the indexing of the data zone is done on the basis of information identifying the user of the zone on the terminal, for one or more consumers with one or more service providers.

9. Implementation of a method according to claim 1 in a microcircuit card (SIM card) of a mobile telephone.
